(19) United States
(12) Patent Application Publication
(10) Pub. No.: US 2011/0289111 A1
(43) Pub. Date: Nov. 24, 2011

(54) Real-time voter identification, contact, and canvassing system

(76) Inventor: Nathan Price Chaney, Arkadelphia, AR (US)

(21) Appl. No.: 13/113,542

(22) Filed: May 23, 2011

Related U.S. Application Data
(60) Provisional application No. 61/347,301, filed on May 21, 2010.

(51) Int. Cl. G06F 17/30

(52) U.S. Cl. 707/769; 707/E17.014

(57) ABSTRACT

A system for the real-time identification, contact, and canvassing of voters is provided. The system has a voter database and a user interface. The user interface displays information about voters from the voter database on a map in the user interface. Households containing registered voters are displayed as pins on the map, and the pin identifies the number of voters within the household and is color-coded to match the presumptive party of the voters within the household. The pins may be clicked to view an individual voter's information, and information about contacts with individual voters may be reported to the voter database in real time. The user may change any number of voter metrics, and the map will automatically refresh to show households containing voters matching such metrics. The user may create, save, and assign walk lists to other users directly from the map based upon the selected voter metrics and current map view. The walk lists may be used to target custom messages to different voters on the walk list depending on a specific set of voter metrics. Campaigns may employ workers armed with smartphones and cellular-enabled tablet computers to canvass voters using the walk lists, or campaigns may use the walk lists in more traditional ways by robocalling or sending mailers to voters on the walk lists. Other features, such as voter searches and user account administration, are also provided.

### CROSS REFERENCES

None.

### GOVERNMENTAL RIGHTS

None.

### BACKGROUND OF THE INVENTION

Political campaigns often require campaign managers to make difficult decisions about how to best seek the support of voters for a candidate or on a ballot issue given restraints on time, campaign funds, and volunteer numbers. Traditionally, local, state, and national political parties have maintained comprehensive lists about voters and where those voters lend their support. If a campaign wished to save money on reaching specific voters by narrowing a list of voters based upon certain factors, a campaign worker had to perform such action by manually editing lists or spreadsheets. Even today, campaign workers spend an inordinate amount of time identifying which voters they wish to target for certain messages. It is an object of the invention to permit a campaign worker to easily and quickly select voters for targeted messages in real time.

Current campaign management software only permits campaign managers to analyze any particular political subdivision on a block level. That is, the campaign manager must make assumptions about individual voters because his or her information is limited to an entire precinct or other large block of voters. Currently, there is no way for a campaign to quickly and easily analyze information about individual voters or households residing in a geographic area of arbitrary size. It is a further object of the invention to permit campaign workers to make informed decisions by viewing information about individual voters and households on a geographic scope of arbitrary size.

Traditional campaigns require inordinate amounts of manpower dedicated to the administrative tasks of identifying, conferring with, and reporting contacts with potential voters. Oftentimes, campaign workers contacting voters on a door-to-door basis will take notes about the responses received during canvassing. Then, upon return to campaign headquarters, the collected information is entered into a central database or otherwise collated with other voter-specific information. This approach to campaign management creates a significant lag time between collection of voter-specific information and the ability of a campaign worker to view and analyze canvassing results. It is another object of the invention to provide real-time reporting of contacts with voters.

The invention meets the above objects by providing a system in which campaign participants may virtually canvass arbitrary portions of political subdivisions involved in a campaign according to specific voter and household metrics and may communicate with one another in real time about detailed, voter- and household-level information.

### BRIEF SUMMARY OF THE INVENTION

A system for the real-time identification, contact, and canvassing of voters is provided. The system comprises a voter database linked to a user interface, which displays information about households containing registered voters as pins on a map. The pins further contain information about individual voters and serve as a gateway to reporting contact with individual voters in real time. While viewing the map, the user may change voter metrics as desired, and the map will refresh to show households containing only voters matching such metrics. The user may create walk lists directly from the map view, and in turn the walk lists may be used to target custom messages to different voters on the walk list depending on a specific subset of voter metrics.

These and other advantages provided by the invention will become apparent from the following detailed description which, when viewed in light of the accompanying drawings, disclose the embodiments of the invention.

### BRIEF DESCRIPTION OF THE DRAWINGS

FIG. 1 is an example of a user interface used by the invention, which is displaying the map option.

FIG. 2 is a block diagram showing the basic components of the voter database that hosts the information displayed by the user interface.

FIG. 3 is a block diagram showing the details of components of a users table within the voter database.

FIG. 4 is a block diagram showing the details of the components of a voter metrics table within the voter database.

FIG. 5 is an example of a user interface showing the map option in which the specific voter metrics for an individual pin on the map are displayed.

FIG. 6 is a block diagram showing the details of components of a household statistics table within the voter database.

FIG. 6a is an example of a user interface showing voter metrics for weighting of Democrat and Republican primary or runoff election votes.

FIG. 7 is a block diagram showing the details of components of a contact reports table within the voter database.

FIG. 7a is an example of a user interface showing how different types of contact with voters can be reported.

FIG. 8 is a block diagram showing the details of components of a walk lists table within the voter database.

FIG. 8a is an example of a user interface in which a custom message is displayed for a user who is contacting a specific voter.

FIG. 9 is an example of an embodiment of a user interface for the invention showing the search option in which the specific voter metrics for a search result are displayed.

FIG. 10 is an example of an embodiment of a user interface for the invention showing the account option.

### LISTING OF COMPONENTS

100—user

101—user interface

103—contact option

105—map option

107—search option

109—account option

111—logout option

113—voter metrics

115—pins

117—map

119—geolocation

121—party affiliation

123—household size

125—minlatlng

127—maxlatlng

129—bounds

131—household statistics

133—download walk list option

135—save walk list option

137—assign walk list option

201—voter database

203—contact reports table

205—walk lists table

207—voter metrics table

209—household statistics table

211—users table

301—owner

303—user creation date

305—user ID

307—client

309—name

311—password

313—access restrictions

315—campaign type

317—political subdivision

319—user type

321—permissions

401—voter ID

403—county

405—date of birth

407—date of registration

409—date of last vote

411—voter name

413—address

415—declared party

417—phone

419—election data

421—election eligibility

423—election type

425—election vote

427—votedD

429—votedR

431—election party

433—election date

435—latitude

437—longitude

439—confidence

441—timestamp

501—popup

503—navigation buttons

505—report contact button

601—count

603—average confidence

605—maximum confidence

607—minimum confidence

609—average age

611—maximum age

613—minimum age

701—contact type

703—contact date

705—contact type table

801—list date

803—list criteria

805—hard list

807—custom messages

808—custom message table

809—message categories

811—message content

813—campaign worker

901—search results

903—map view feature

1001—user summary

1003—campaign summary

1005—contact report functions

1007—walk list functions

1009—user functions

### DETAILED DESCRIPTION OF THE INVENTION

The invention comprises a system and method of real-time voter identification, contact, and canvassing for use by an election campaign. The invention permits a campaign manager, politician, public official, or other interested person to virtually canvass arbitrary portions of a geographic area containing constituents, to identify and tag voters for further contact, and to track contacts with voters when such contacts are made.

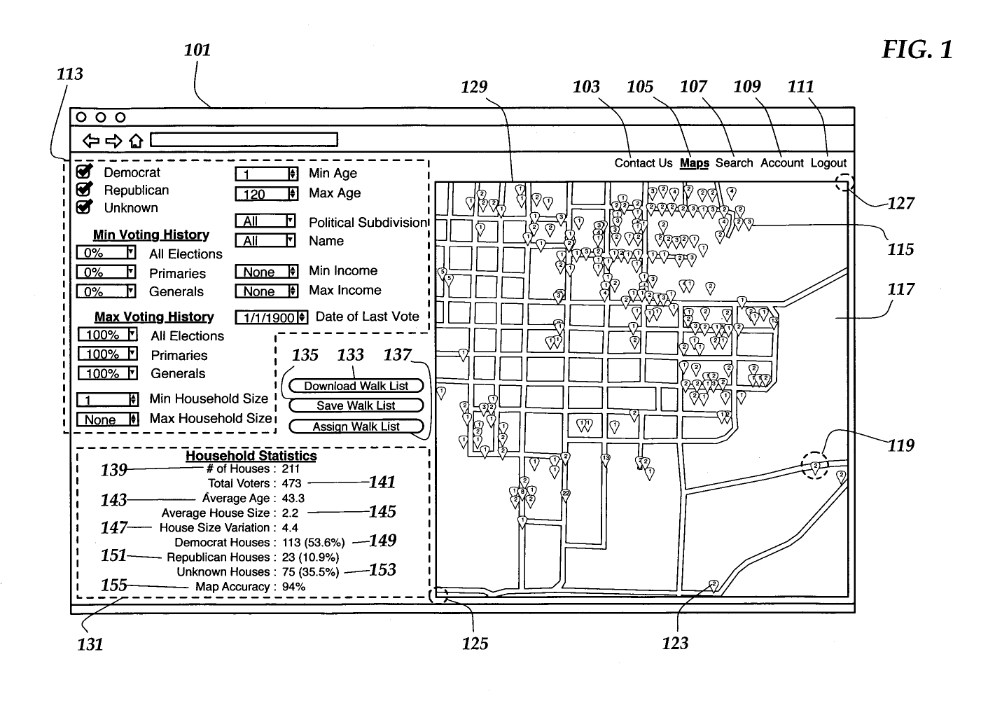

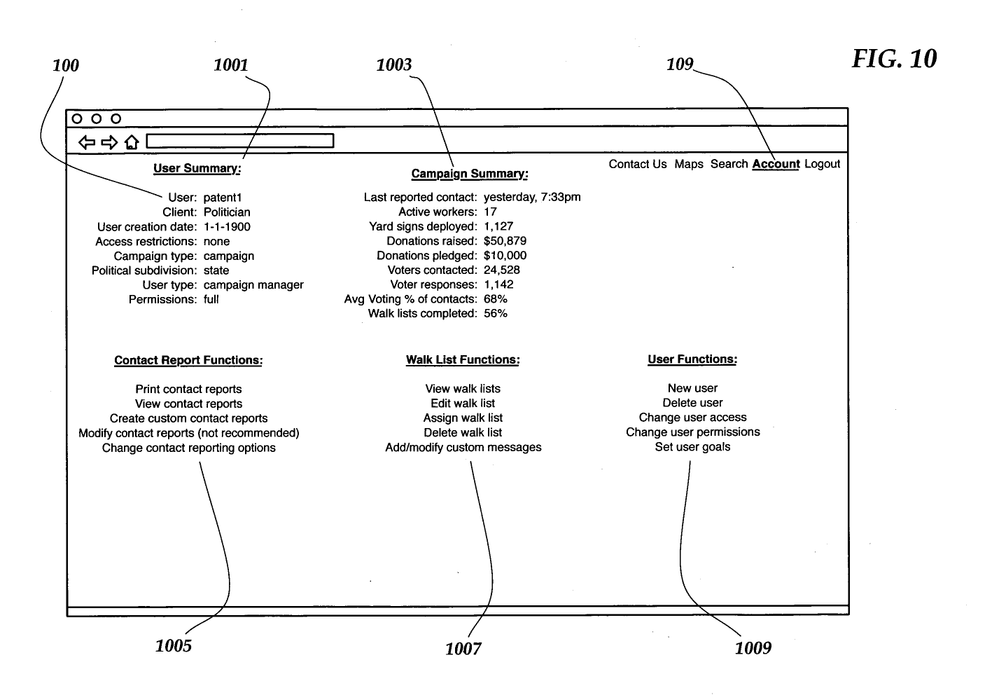

Turning now to FIG. 1, a user 100 (shown only in FIG. 10) logs into a user interface 101, preferably in a secure fashion. User interface 101 has at least five options: a contact option 103, a map option 105, a search option 107, an account option 109, and a logout option 111. FIG. 1 depicts an example of map option 105. Map option 105 permits user 100 to select from a number of different voter metrics 113. Zero or more pins 115 represent households in which voters reside who match voter metrics 113, which are plotted on a map 117. FIG. 1 represents a map 117 plotting all voters, meaning that voter metrics 113 are as broad as possible. Pins 115 represent at least three types of information: geolocation 119, party affiliation 121, and household size 123. Geolocation 119 is represented by the location of pin 115 on map 117. Party affiliation 121 is represented by the color of pin 115; preferably, pin 115 is blue when party affiliation 121 of the represented household is Democrat, red when party affiliation 121 of the represented household is Republican, and green or yellow when party affiliation 121 of the represented household is unknown (due to the drawing rules of the USPTO, the color of pins 115 and thus the party affiliation 121 are not indicated in FIG. 1). For households containing more than one voter, the color of pin 115 depends upon a comparison of the total number of votes within the household in each political party's respective primary elections.

Map 117 represents a view of a particular geographic location, preferably a geographic location in which constituents reside who are important to user 101. Even more preferably, when user 100 logs into user interface 101, user interface 101 is capable of providing geolocation information along with login information such that map 117 is substantially centered on the current physical location of user 100. Also, it is preferable that user interface 101 can continue to provide geolocation information such that map 117 can be re-centered on the physical location of user 100 as user 100 canvasses or otherwise moves around a geographic area. Map 117 is bounded by a minimum latitude and longitude, referred to as minlatlng 125, and a maximum latitude and longitude, referred to as maxlatlng 127. Together, minlatlng 125 and maxlatlng 127 are referred to as bounds 129. Information about households in which voters reside is plotted on map 117 with pins 115, and information about every pin 115 on map 117 is summarized as an average; these averages are shown as household statistics 131.

Voter metrics 113 and bounds 129 may be changed in real time by user 100. When user 100 changes voter metrics 113, map 117 automatically refreshes and redraws pins 115 matching the new voter metrics 113 selected by user 100. When user 100 changes bounds 129, such as by dragging map 117, zooming map 117 in or out, double-clicking map 117, or otherwise changing bounds 129 as permitted by user interface 101, map 117 automatically refreshes and redraws pins 115 matching voter metrics 113 selected by user 100. Household statistics 131 also automatically refresh and show household statistics 131 matching voter metrics 113 and bounds 129 selected by user 100. By referring to pins 115 on map 117 and to household statistics 131, user 100 may change voter metrics 113 and bounds 129 to suit the particular needs of user 100.

Once user 100 has set bounds 129 and voter metrics 113 as user 100 sees fit, user 100 may select one of several options, including but not limited to a download walk list option 133, a save walk list option 135, or an assign walk list option 137. Download walk list option 133 permits user 100 to download a file containing names, addresses, party affiliations, voting history, or other pertinent or desired information about the voters identified by pins 115. Save walk list option 135 permits user 100 to name and store a list of desired information about the voters identified by pins 115. Assign walk list option 137 permits user 100 to name and store a list of desired information about the voters identified by pins 115, and to assign such list to another user 100 for completion of a desired assignment.

One having ordinary skill in the art will recognize that voter metrics 113 depicted in FIG. 1 are not an exclusive or exhaustive list. As shown in FIG. 1, voter metrics 113 include selections indicating whether a voter is Democrat, Republican, or of unknown party affiliation; the voter's voting history percentage in a given type of election; the voter's household size (which requires that other voters in the household likewise match all other voter metrics 113); or the voter's age, political subdivision, income level, or date of last vote. Voter metrics 113 may also include additional information relevant to a campaign's interests, including but not limited to past campaign or political contributions; past political or campaign support; past political or campaign participation; personal relationships between voters, candidates, and/or campaign workers, including social networking relationships; responses to political polls; and countless other categories of campaign-relevent information.

FIG. 1 contains an example of various types of household statistics 131. For instance, in FIG. 1, number of houses 139 indicates that there are 211 pins 115. Total voters 141 indicates that map 117 displays 473 total voters. Average age 143 indicates that the residents of the average household depicted on map 117 have an average age 43.3. Average house size 145 is equal to 2.2. House size variation 147 refers to the standard deviation of number of voters residing in each household for the set of pins 115, which is 4.4. House size variation 147 permits user 100 to identify that map 117 depicts a residential neighborhood when the house size variation 147 is comparably low relative to average house size 145, and a neighborhood containing apartments, colleges, or other high-density residences when house size variation 147 is comparably high relative to average house size 145. Democrat houses 149 depicts the number of pins 115 representing households that tend to vote in Democratic primary and runoff elections. Republican houses 151 depicts the number of pins 115 representing households that tend to vote in Republican primary and runoff elections. Unknown houses 153 depicts the number of pins 115 representing households of unknown probable party affiliation. Map accuracy 155 represents an average of the confidence in the accuracy of the location of each pin 115. This confidence metric is provided when geolocation 119 is obtained for each household from a geocoding service, which will be discussed in more detail later.

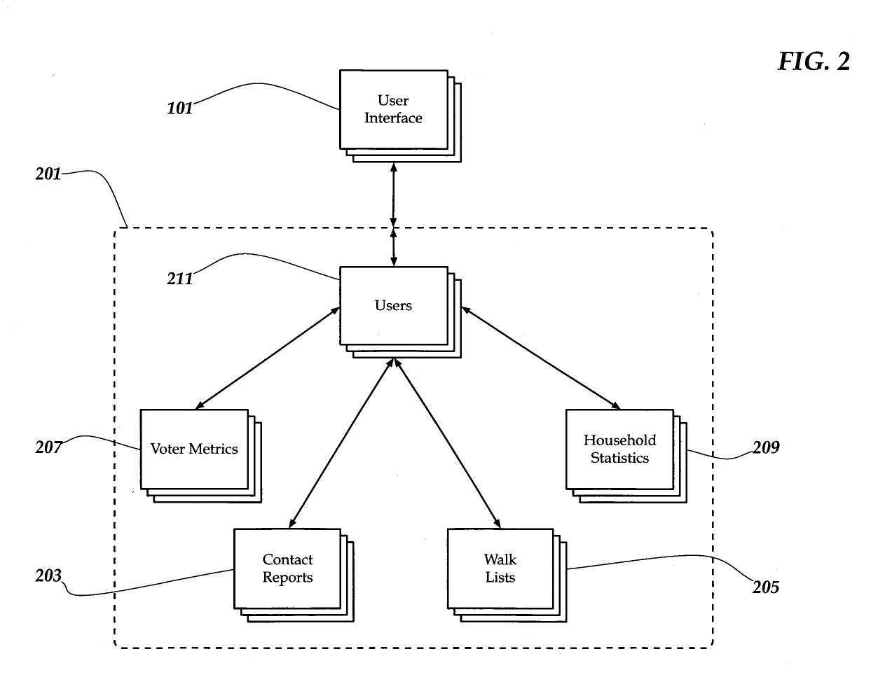

Turning now to FIG. 2, user interface 101 is linked to a voter database 201. Voter database 201 comprises a contact reports table 203, a walk lists table 205, a voter metrics table 207, a household statistics table 209, and a users table 211. Voter database 201 interacts with user interface 101 primarily through users table 211; this limitation only permits user interface 101 to have access to data for which an individual user 100 is authorized. Also, such limitation permits queries of voter database 201 to be narrowed to information for which user 100 has access, thereby limiting the size of queries to voter database 201 and increasing the speed with which such queries can be processed and returned to user interface 101.

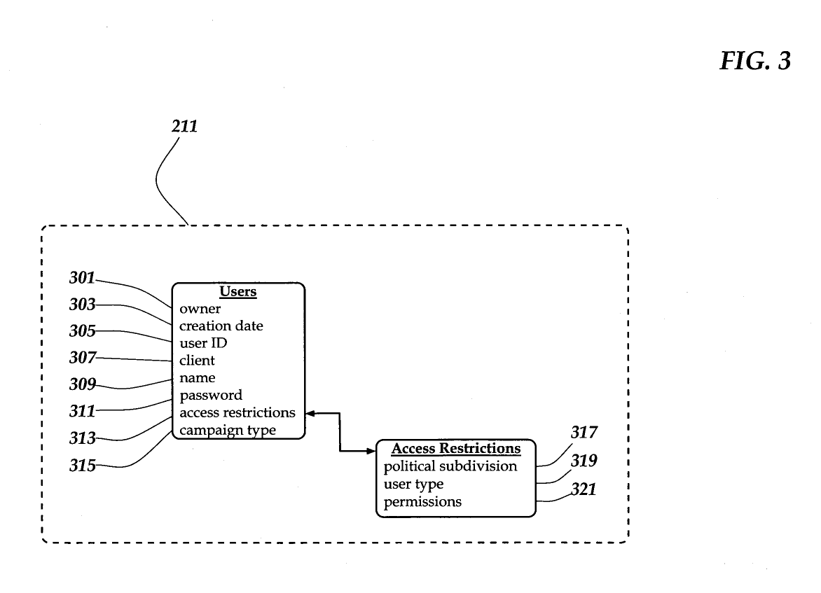

Turning now to FIG. 3, users table 211 contains various information, such as an owner 301 of user 100, user creation date 303, user ID 305, client 307, name 309, password 311, access restrictions 313, and campaign type 315. Name 309 and password 311 permit user 100 to log into user interface 101. Client 307 indicates the particular campaign with which user 100 is associated. Access restrictions 313 dictate a political subdivision 317 involved for a particular user 100, such as a county, state judicial district, state senate district, precinct, or the like. Limitations on political subdivision 217 have the added benefit of speeding up queries of voter database 201. Access restrictions 313 also specify a user type 319 for user 100, such as campaign manager, campaign worker, campaign volunteer, or the like; user type 319 specifies how a particular user 100 may interact with voter database 201. Access restrictions 313 also include permissions 321, which may be set for users 100 by other users 100. Permissions 321 permit campaign workers to limit access to the voter database 201 for users 100 on a user-by-user basis as necessary.

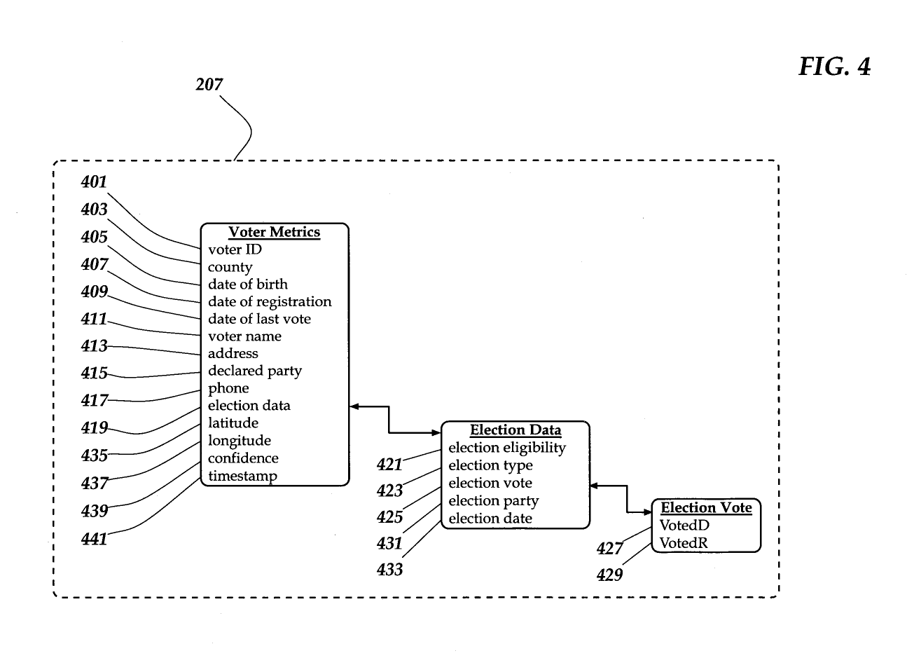

Turning now to FIG. 4, voter metrics table 207 contains various information, such as voter ID 401, county 403, date of birth 405, date of registration 407, date of last vote 409, voter name 411, address 413, declared party 415, phone 417, election data 419 (further comprising election eligibility 421, election type 423, election vote 425 (further comprising votedD 427 and votedR 429), and election party 431), latitude 435, longitude 437, confidence 439, and timestamp 441. Date of birth 405 is used to calculate a voter's age. Date of registration 407 is used to calculate election eligibility 421, which identifies whether a voter was eligible to vote in a particular election. Address 413 is used to obtain latitude 435, longitude 437, and confidence 439 using a geocoding service, which will be discussed later. Declared party 415 may be used to color pins 115 and other information such as voter name 411, if such information has been provided by a voter. VotedD 427 and votedR 429 are calculated from election vote 425 (which indicates whether a voter voted in a particular election), election type 423 (which indicates whether a particular election was party-specific, such as a primary or runoff election), and election party 431. Timestamp 441 indicates the date and time the voter's latitude 435, longitude 437, and confidence 439 were last updated using a geocoding service.

In some circumstances, election data 419 contains bugs from the provider (provision of election data 419 will be discussed later). For instance, the inventor is aware of some circumstances where the provider of election data 419 overwrites date of registration 407 with the date when a voter re-registered to vote in a different political subdivision 317. In this situation, a voter's election data 419 may indicate that the voter voted prior to date of registration 407. In such a situation, date of registration 407 should be reset to election date 433 of the earliest election in which the voter voted. Otherwise, the household statistics 131 for a particular household or other information displayed in user interface 101 may be erroneous or nonsensical.

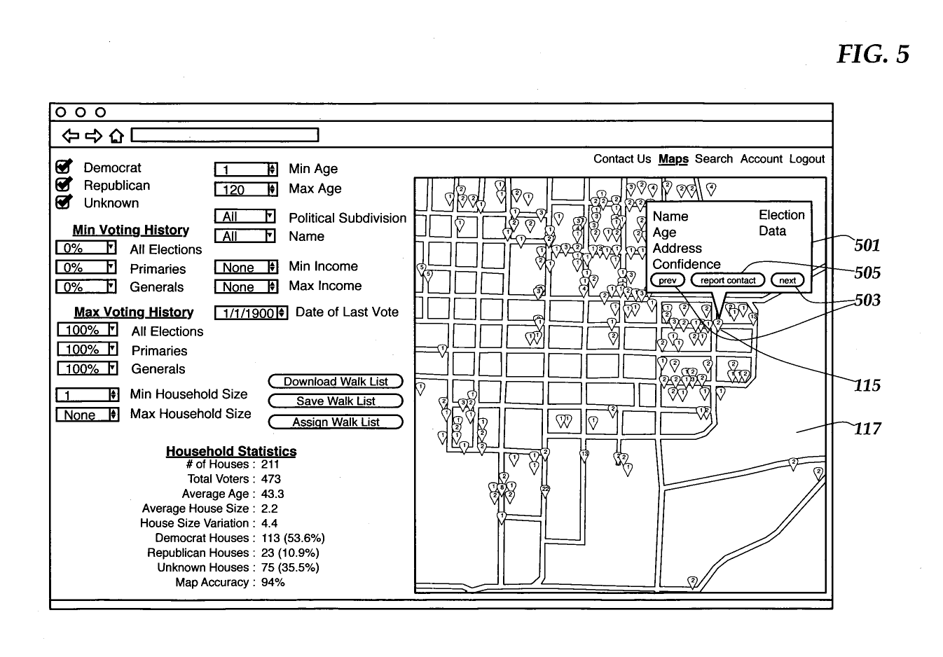

Turning now to FIG. 5, a user 100 may interact with map 117. One method of interacting with map 117 includes clicking on pin 115, which prompts user interface 101 to display popup 501. Popup 501 may contain various information, such as voter name 411, address 413, election data 419, and confidence 439. For households containing more than one voter, navigation buttons 503 permit user 100 to view the information for each voter residing in the household. Report contact button 505 permits user 100 to input information about a voter into the contact reports table 203.

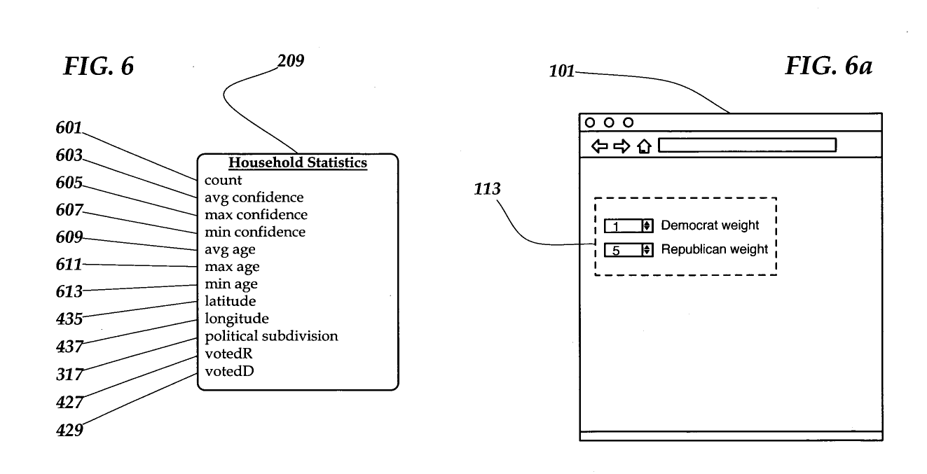

Turning now to FIG. 6, the household statistics table 209 contains various information, such as count 601, average confidence 603, maximum confidence 605, minimum confidence 607, average age 609, maximum age 611, minimum age 613, latitude 435, longitude 437, political subdivision 317, votedD 427 (times voted in Democratic elections such as primaries and runoffs), and votedR 429 (times voted in Republican elections such as primaries and runoffs). The information contained within household statistics table 209 is used to populate map 117 with pins 115 in user interface 101 when user 100 selects various voter metrics 113. That is, household statistics table 209 contains a collation of voter metrics 113 for all voters residing in each particular household, each of which is represented by pin 115 in user interface 101. Each voter having identical latitude 435 and longitude 437 is considered to reside in the same household. The information contained within household statistics table 209 is very similar to the information contained within the voter metrics table 207, but is provided on a household basis because pins 115 are displayed in user interface 101 on a household basis. A person having ordinary skill in the art will recognize that household statistics table 209 could be calculated on an as-needed basis from the information contained within voter metrics table 207. However, the best mode known to the inventor is to utilize separate tables for the household statistics table 209 and voter metrics table 207 in order to maximize the speed with which pins 115 and household statistics 131 are displayed in user interface 101.

Every time map 117 is displayed or updated, user interface 101 queries voter database 201 with at least voter metrics 113, minlatlng 125, and maxlatlng 127. Voter database 201 selects those pins matching voter metrics 113 within bounds 129 defined by minlatlng 125 and maxlatlng 127, and returns sufficient information to user interface 101 for relevant pins 115 to be displayed on map 117.

A comparison of votedD 427 and votedR 429 from household statistics table 209 is used to determine the color of pins 115 on map 117. Likewise, a comparison of votedD 427 and votedR 429 from voter metrics table 207 is used to determine the color of voter name 411 in popup 501 (as shown in FIG. 5).

In many political subdivisions across the country, voter metrics 113 concerning party affiliation are difficult to discern. Many voters do not specify a declared party 415. In such situations, users 100 can glean information about a voter's party affiliation by looking to the type of political primaries in which a voter votes. In some regions, far more candidates run in primaries as Democrats, and the converse is true as well. In those regions, it may be advantageous to give greater weight to a voter's voluntary participation in party-specific elections concerning the party generally having fewer party-specific elections. For instance, in some parts of the South, most candidates run as Democrats because even conservative candidates self-identify themselves as “blue dog” Democrats. In such a situation, a person who voluntarily elects to vote in a Republican primary is quite likely to be Republican, even if that person also votes in more Democratic primaries than Republican ones. Thus, in these types of situations, it is advantageous to weight votes in Republican primaries more heavily than votes in Democratic primaries. User interface 101 may have a voter metric 113 directed toward weighting of party-specific votes, as depicted in FIG. 6a.

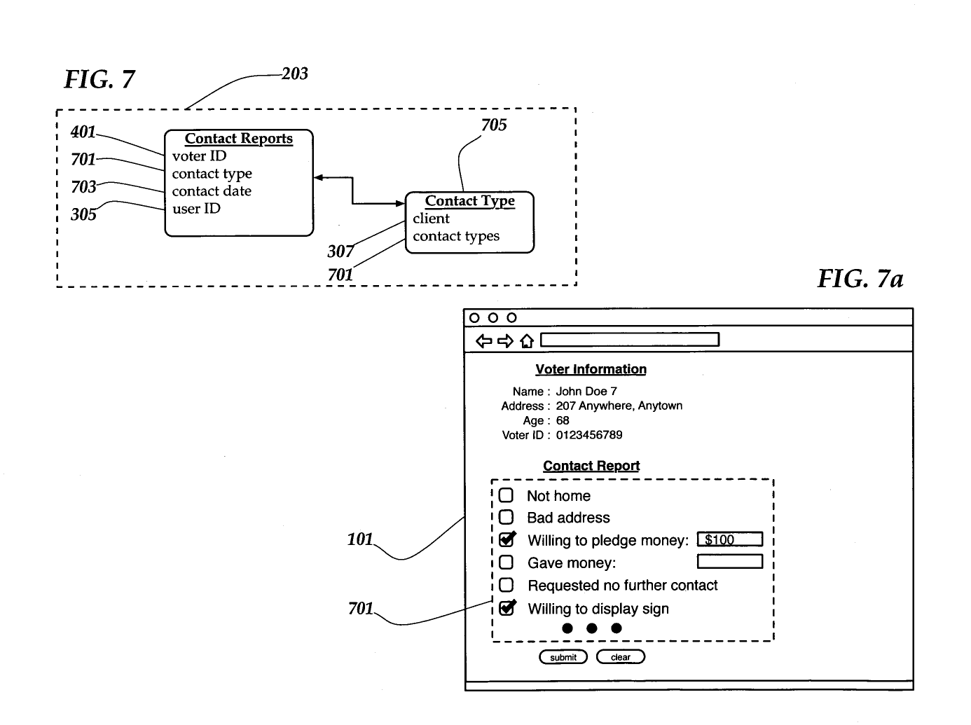

Turning now to FIG. 7, contact reports table 203 contains information inputted by users 100 about contacts made with specific voters. Such information may include voter ID 401, contact type 701, contact date 703, and user ID 305. Voter ID 401 and user ID 305 are included within contact reports table 203 in order to associate contact with the voter with a specific campaign; in this manner, multiple contacts with the same voter by different campaigns may be tracked. Contact date 703 permits tracking of multiple contacts with the same voter during the same campaign.

As illustrated in FIG. 7a, possible values for contact type 701 include, but are not limited to the following: signed petition, refused petition, not home, bad address, gave specific dollar amount, pledged specific dollar amount, willing to volunteer, willing to display sign, requested no further contact, other, come back later, or any number of campaign-related fields. Contact types 701 may be defined by a particular campaign and drawn from a separate contact type table 705 within voter database 201 (not shown in FIG. 2), which has fields for client 307 (i.e., campaign) and a list of contact types 701. Accordingly, each client 207 can specific the contact types 701 relevant to the campaign of client 307.

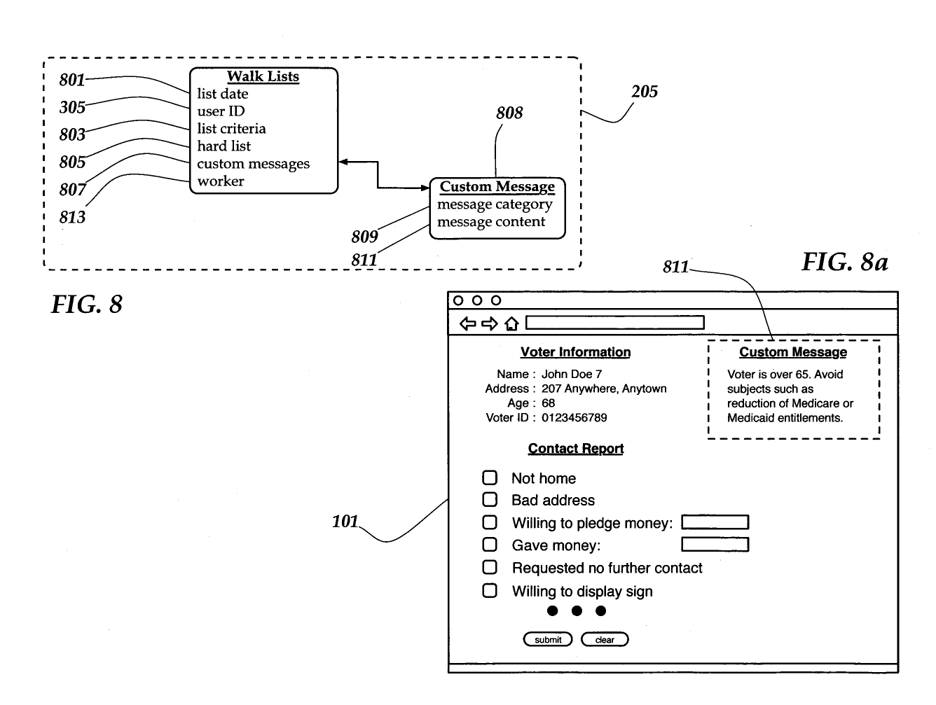

Turning now to FIG. 8, walk lists table 205 contains information about voters matching voter metrics 113 chosen by users 100 in specific geographic bounds 129 and/or political subdivisions 317. Such information may include a list date 801 and a user ID 305.

Individual walk lists in walk lists table 205 may be stored in at least two forms. First, a walk list may be stored as a set of list criteria 803; that is, list criteria 803 are stored values corresponding to the voter metrics 113 chosen by user 100 when viewing user interface 101. List criteria 803 may include selections indicating whether a voter is Democrat, Republican, or of unknown party affiliation; the voter's voting history percentage in a given type of election; the voter's household size (which requires that other voters in the household likewise match all other voter metrics 113); or the voter's age, political subdivision, income level, or date of last vote. Additionally, list criteria may include information relevant to a campaign's interests, including but not limited to past campaign or political contributions; past political or campaign support; past political or campaign participation; personal relationships between voters, candidates and/or campaign workers, including via social networking; responses to political polls; and countless other categories of campaign-relevant information. Storing an individual walk list as a set of list criteria 803 permits the walk list to automatically update each time the walk list is viewed by user 100.

Second, an individual walk list may be stored as a hard list 805. Hard list 805 is a flat file containing minimum information sufficient to permit a campaign worker to use the list to canvass a given area or otherwise contact a given set of voters. For electronic use, hard list 805 may be stored as a list of voter IDs 401. Traditionally, hard list 805 is a paper document containing a list of up to several thousand voter names 411, addresses 413, phone numbers 417, declared party 415, or other political affiliation identifiers of the voters appearing on the walk list. Walk lists may be used to send targeted mailouts, robocalls, or emails, or may be used to send campaign workers to a given area for door-to-door canvassing.

Regardless of the method by which each walk list is stored, the invention permits use of walk lists by traditional means (i.e., paper) or by dynamic use of user interface 101 via personal computer, smartphone, tablet computer, or other electronic device capable of displaying and interacting with data, preferably a portable device that is capable of determining geolocation. When walk lists are used interactively by a campaign worker to canvass a geographic area, it may be preferable to use the entire display of user interface 101 to display map 117. In such configuration, neither voter metrics 113 nor household statistics 131 are displayed, which has the additional benefit of speeding up the loading and display of map 117 because the household statistics 131 queries are not required.

Walk lists table 205 also contains an option for custom messages 807, which is drawn from a custom message table 808 containing campaign-defined messages. Custom message 807 permits a campaign to identify and label several message categories 809 which identify voters having distinct groupings of voter metrics 113. Each message category 809 is associated with different message content 811 designed to best capture the attention and support of a voter matching the unique set of voter metrics 113 associated with message category 809. For instance, if a voter is known to be a contributor to the National Rifle Association, a user 100 contacting such voter should refrain from conveying message content 811 relating to support for gun control. Custom messages 807 may be implemented with specific walk lists in several ways. For hard lists 805 printed in the traditional manner, each voter may be associated with message category 809 which requires user 100 contacting such voter to cross reference with a printed list that matches message categories 809 with message content 811. For walk lists 205 utilized on newer technology such as smartphones or tablet computers, message content 811 can be automatically displayed when user 100 initiates contact with the voter, such as by activating report contact button 501 (as shown in FIG. 8a). Campaign workers 813 may be assigned to walk lists so that users 100 can delegate appropriate tasks associated with each walk list.

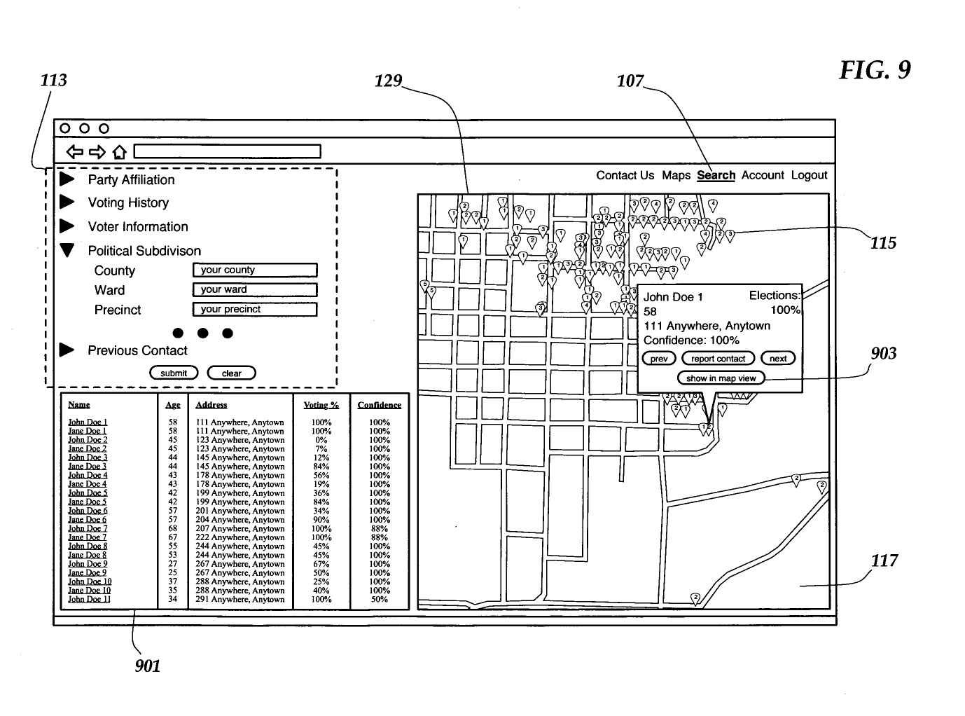

Turning now to FIG. 9, an example of search option 107 is depicted. User 100 may enter specific data into search fields corresponding to any voter metric 113 maintained in voter database 203. In this example, user 100 has elected to search voter database 203 by the political subdivision voter metric 113. Search results 901 list information specific to each voter, and the results of the search dictate the size of bounds 129. That is, bounds 129 is calculated from the latitudes 435 and longitudes 437 of pins 115, rather than being calculated from the size of map 117. As seen by comparing FIG. 1 with FIG. 9, search results 901 display only information meeting voter metrics 113 specified by user 100. For search option 107, popup 501 has an additional map view feature 903 which, when activated, opens map option 105 centered on the location identified by the pin 115 from which popup 501 was triggered.

Turning now to FIG. 10, an example of account option 109 is depicted. Account option 109 displays user summary 1001 and campaign summary 1003 to provide a snapshot of the campaign's progress. Account option 109 further permits user 100 to make changes to various aspects of the account of such user 100, including tasks regarding contact report functions 1005, walk list functions 1007, and user functions 1009. The structure of the various components of voter database 203 has been discussed above, and it is within the capabilities of a person having ordinary skill in the art to modify or add data to a preexisting database; that is, the calculation and display of user summary 1001 and campaign summary 1003 is within the ordinary skill of the art given the detailed description above, as is the implementation of contact report functions 1005, walk list functions 1007, and user functions 1009.

According to the best mode known to the inventor, the invention is implemented using a general-purpose computer as a web host, which uses the FreeBSD operating system version 7.2. User interface 101 may be implemented using the Apache web server version 2.2.13, the MySQL database version 5.0.67, the PHP server-side scripting language version 5.2.12, and the Javascript client-side scripting language as implemented by most modern web browsers. Preferably, user interface 101 is securely implemented using SSL certificates. Such web hosting configuration can be obtained from Pair Networks, Inc., Pittsburgh, Pa. A person having ordinary skill in the art will recognize that countless other combinations of client-server hardware and database/web hosting software may be used to implement the invention.

Information used to populate voter metrics table 207, including election data 419, may be obtained from public repositories of registered voter information. Most state election officials, including the Secretary of State for the State of Arkansas, will provide a flat voter file on disc upon a properly-termed Freedom of Information request. Many local election officials can perform a similar service. Other possible sources of voter information include local, state, and national political parties.

The web browser Firefox version 3.6 and above, or most mobile web browsers, provide the best viewing experience for user interface 101. Such browsers offer geolocation services, which permit the browser to report its geolocation to Javascript, which in turn may use the geolocation information to dynamically update portions of user interface 101 using the AJAX (asynchronous Javascript) protocol. Many other web browsers for general-purpose computers cannot automatically ascertain the geolocation of the computer, and the effectiveness of user interface 101 is somewhat diminished for a canvasser by the lack of a geolocation feature in a browser. For a campaign manager, geolocation capability is not as important, since the campaign manager typically does not perform door-to-door contact him- or herself but instead assigns other campaign workers to such tasks.

User interface 101 may utilize geocoding and mapping services provided by Google Maps API. Latitude 435, longitude 437, and confidence 439 may be obtained by submitting an address 413 to Google's geocoding service. Maps 117, the placement of pins 115 on maps 117, and the operation of popups 501 may be implemented using the Google Maps API. A person having ordinary skill in the art will recognize that other providers of geolocation and mapping APIs may be used to implement the invention.

While the inventor has described above what he believes to be the preferred embodiments of the invention, persons having ordinary skill in the art will recognize that other and additional changes may be made in conformance with the spirit of the invention, and the inventor intends to claim all such changes as may fall within the scope of the invention.

I claim:

1. A real-time voter identification, contact, and canvassing system comprising:
A user interface for a user, further comprising an interactive map having geographic bounds;
A voter database populated with information about individual voters, further comprising geolocation information about such individual voters;
Selecting from the voter database and displaying the geolocation of one or more households at which one or more individual voters reside on the interactive map.

2. The real-time voter identification, contact, and canvassing system of claim 1, wherein the user may select an individual voter on the interactive map and report a personal contact attempt with such individual voter for recording in the voter database.

3. The real-time voter identification, contact, and canvassing system of claim 1, wherein the user may select an individual voter on the interactive map, receive predetermined instructions for contacting such individual voter according to such individual voter's voter metrics, and report a personal contact attempt with such individual voter for recording in the voter database.

4. The real-time voter identification, contact, and canvassing system of claim 1, wherein the information displayed on the interactive map about each household includes the number of voters within each such household.

5. The real-time voter identification, contact, and canvassing system of claim 1, information about the political preferences of the individuals voters residing in each such household.

6. The real-time voter identification, contact, and canvassing system of claim 1, wherein the user may manipulate the interactive map by selecting voter metrics in the user interface in order to determine which individual voters' geolocations are displayed on the interactive map.

7. The real-time voter identification, contact, and canvassing system of claim 1, wherein the user may manipulate the interactive map by selecting voter metrics in the user interface in order to determine which individual voters' geolocations are displayed on the interactive map, and wherein the user may save a walk list of the individual voters whose geolocations are displayed on the interactive map.

8. The real-time voter identification, contact, and canvassing system of claim 1, wherein the user may manipulate the interactive map by selecting voter metrics in the user interface in order to determine which individual voters' geolocations are displayed on the interactive map, and wherein the user may assign to another user a walk list of the individual voters whose geolocations are displayed on the interactive map.

9. The real-time voter identification, contact, and canvassing system of claim 1, wherein the individual voters' geolocations are displayed on the interactive map using a predetermined walk list of individual voters.

10. The real-time voter identification, contact, and canvassing system of claim 1, wherein the user interface further comprises a set of household statistics derived from the voter

11. The real-time voter identification, contact, and canvassing system of claim 1, wherein the user interface is geolocation-capable such that the map can be re-centered on the physical location of the user as the user moves around a geographic area.

12. The real-time voter identification, contact, and canvassing system of claim 1, wherein the user interface is geolocation-capable such that the map can be re-centered on an arbitrary geographic location.

13. The real-time voter identification, contact, and canvassing system of claim 1, wherein the user interface comprises a tablet computer.

14. The real-time voter identification, contact, and canvassing system of claim 1, wherein the user interface comprises a mobile telephone.

15. The real-time voter identification, contact, and canvassing system of claim 1, wherein the user interface comprises a portable, geolocation-capable device.

16. A real-time voter identification, contact, and canvassing system comprising:
A user interface for a user, further comprising an interactive map having geographic bounds, wherein the user interface is geolocation-capable such that the map can be re-centered on the physical location of the user as the user moves around a geographic area;
A voter database populated with information about individual voters, further comprising geolocation information;
Selecting from the voter database and displaying the geolocation of one or more households at which one or more voters reside on the interactive map;
Wherein the user may select an individual voter on the interactive map and report a personal contact attempt with such individual voter for recording in the voter database.
